(19) United States
(12) Patent Application Publication
(10) Pub. No.: US 2016/0201699 A1
(43) Pub. Date: Jul. 14, 2016

(54) GENERATING WAVEFORMS, SUCH AS STANDING OR PROPAGATING WAVES, IN A MULTI-FLUID ELECTROWETTING SYSTEM

(71) Applicant: ABL IP HOLDING LLC, Conyers, GA (US)

(72) Inventors: Jason Charles HEIKENFELD, Cincinnati, OH (US); Wan-Lin Hsieh, Taoyuan City (TW)

(21) Appl. No.: 14/989,322

(22) Filed: Jan. 6, 2016

Related U.S. Application Data
(60) Provisional application No. 62/101,120, filed on Jan. 8, 2015.

(51) Int. Cl. F15D 1/00; G01N 27/447; B01L 3/00

(52) U.S. Cl. CPC F15D 1/0065; B01L 3/50273; B01L 3/502715; B01L 3/502776; G01N 27/44791; G01N 27/44713; B01L 2300/0645; B01L 2300/165; B01L 2400/0427; B01L 2300/168; B01L 2200/0636

(57) ABSTRACT

A multiple-fluid system generates waveforms at its fluid interface, e.g. in a manner to prevent complete dewetting of a surface by the electrically non-conductive fluid and/or wetting of the surface by the electrically conductive fluid. In an example, a feedback controller senses capacitance across the non-conductive fluid, e.g. between one or more electrodes on the substrate and the conductive fluid. This first example controls voltages applied to the electrodes, based on the capacitive sensing, to create a static waveform, such as a standing wave, at the fluid interface. Another example manipulates the voltages applied to the electrodes to generate a propagating wave at the fluid interface.

### CROSS REFERENCE TO RELATED APPLICATION

This application claims the benefit of U.S. Provisional Application No. 62/101,120 filed Jan. 8, 2015, entitled “PREVENTING COMPLETE DEWETTING WHEN TREATING A SUBSTRATE WITH TWO FLUIDS” the disclosure of which also is entirely incorporated herein by reference.

### BACKGROUND

Electrical control of the shape of an interface between multiple fluids is common in technologies such as liquid lenses as well as lab-on-chip devices. Such a system includes a substrate with one or more electrodes covered by a dielectric, an insulating or non-conductive fluid adjacent the dielectric and a conductive fluid. Conventional methods of control in multiple fluid systems may result in a complete dewetting of the insulating fluid from the dielectric, allowing the electrically conductive fluid, such as water, to reach the dielectric. The droplets of the electrically conductive fluid that reach the dielectric on the substrate negatively impact the dielectric on the substrate.

Conventional methods of control of multiple fluids includes the generation of simple periodic symmetric waves into the fluids as well as creating menisci with spherical geometries limited to two principle radii of curvature. Such conventional methods lack the ability to control the generated waveform injected into the fluids so that the thickness of the insulating fluid, such as oil, is adjusted so that a minimum thickness in the insulating fluid is reached that prevents complete dewetting of the dielectric, and lack the ability to create non spherical menisci.

### SUMMARY

In an example, an apparatus has a substrate and first and second fluids, immiscible with respect to each other. The first fluid is insulating and located between the substrate and the second fluid. The apparatus also includes at least one electrode formed adjacent to the substrate and adjacent to the first fluid. The electrode is configured to generate an electric field in the vicinity of the electrode extending through the first fluid, in response to a voltage applied to the electrode. The apparatus also includes a controller coupled to apply voltage to the electrode(s). The detailed description encompasses a number of examples utilizing this general type of apparatus.

In one type of example, the apparatus also includes a second electrode in contact with one of the fluids, and the controller is coupled to the first and second electrodes. The controller is configured to measure capacitance between the first and second electrodes as an indication of thickness of the first fluid in vicinity of the first electrode and to control the voltage applied to the first electrode in response to the sensed capacitance.

In another type of apparatus example, there are a plurality of electrodes formed adjacent to the substrate and adjacent to the first fluid, at locations distributed across the surface of the substrate. In this type apparatus, each respective one of the electrodes is configured to generate an electric field in the vicinity of the respective electrode extending through the first fluid, in response to a respective voltage applied to the respective electrode. Also, the controller is coupled to vary respective voltages applied to the electrodes to generate a propagating wave at the interface between the first and second fluids.

The detailed description also discloses an example of an apparatus that includes a first substrate, a second substrate spaced from the first substrate to form a volume between the second substrates, as well as first and second fluids, immiscible with respect to each other, in the volume between the substrates. The first fluid is insulating and nearest to the first substrate, and the second fluid is conductive and nearest to the second substrate. In this apparatus example, electrodes are adjacent to the first substrate and adjacent to the first fluid, at locations distributed across the surface of the first substrate. Each respective one of the electrodes is configured to generate an electric field in the vicinity of the respective electrode extending through the first fluid, in response to a respective voltage applied to the respective electrode. This apparatus also includes a controller coupled to control respective voltages applied to the electrodes to generate a complex waveform geometry at an interface between the first and second fluids.

Several other features are disclosed that may be used in one or more of the examples of apparatuses as outlined above. For example, the controller may be further configured to control voltage(s) applied to the electrode(s) so as to generate the waveform geometry without need for a contact angle change for the second fluid on an adjacent solid surface. Another example of a possible additional feature is that the controller may be further configured to control applied voltage or voltages to at least substantially prevent dewetting by the first fluid and/or wetting by the second fluid.

The electrofluidic technologies may produce a variety of different types of complex static or propagating waves, which for example can include harmonic, linear, non-linear, corners, convex/concave areas, ripples, non-spherical protrusions or cavities, or other geometries or shapes in any dimension along the meniscus surface of the insulating fluid.

Applications of the technologies include optical applications, such as a lens, a prism, an array of lenses, an array of prisms, a diffraction grating, an optical phased array or a Fresnel lens. Other optical applications may be reflective. To implement a tunable reflective optic, for example, an electrofluidic apparatus may further include nano or micro-particles suspended between the first and second fluids to provide reflectivity at the interface. Applications, however, are not limited to processing light. Other application examples include particle or fluid transport (e.g. lab-on-chip) devices. The technologies may also be useful in displays and other applications.

Further features and advantages, as well as the structure and operation of the various examples, are described in detail below with reference to the accompanying drawings.

### BRIEF DESCRIPTION OF THE DRAWINGS/FIGURES

Examples are described with reference to the accompanying drawings. In the drawings, like reference numbers may indicate identical or functionally similar elements.

FIG. 1A illustrates a feedback configuration that implements a feedback approach in preventing complete dewetting of a dielectric on the substrate;

FIG. 1B illustrates a propagating configuration that implements a propagating wave approach in preventing complete dewetting;

FIG. 2A illustrates a time evolution of the oil film dewetting process;

FIG. 2B illustrates an electric field calculated at the dielectric layer surface during the dewetting process;

FIG. 2C illustrates timing for the periodic wave profile;

FIG. 2D illustrates a plot of amplitude A and oil film minima hₒᵢₗ;

FIG. 3 illustrates a plot of the time evolution of the oil film thickness;

FIG. 4A illustrates a feedback control configuration that prevents complete dewetting of the dielectric;

FIG. 4B illustrates a plot of the oil film thickness hₒᵢₗ;

FIG. 5A illustrates an asymmetric triangular profile based on the feedback control configuration;

FIG. 5B illustrates the plot of the oil film thickness hₒᵢₗ;

FIG. 5C illustrates a plot of the fluid film profile with hₒᵢₗ=10 μm;

FIG. 5D illustrates a plot of the fluid film profile with hₒᵢₗ=20 μm;

FIG. 6A illustrates saw-tooth profiles according to a Fourier series approximation;

FIG. 6B illustrates saw-tooth profiles of the 10 basis functions of the Fourier series approximation;

FIG. 7A illustrates a propagating wave control configuration that prevents complete dewetting;

FIG. 7B illustrates three different driving waveforms implemented in the propagating wave control configuration;

FIG. 7C illustrates a simulated wave propagation using triangular profiles; and

FIG. 8 illustrates an oil dewetting pattern in an electrowetting pixel;

### DETAILED DESCRIPTION

The disclosure generally relates to multiple fluid systems and the operation thereof to generate waveforms at fluid interfaces, e.g. in a manner to prevent complete dewetting by the electrically non-conductive fluid. The technologies described below are distinct from conventional electrowetting, where waveforms at a fluid interface are generated by a contact angle change which requires a conducting fluid to contact an electrowetting surface. In the present disclosure, no such contact angle is required, as the underlying physics of the presently disclosed electrofluidic devices and operations are distinct. For example, in a conventional electrowetting system, as known by one skilled in the art of microfluidics and electrowetting, a stable contact angle on a solid electrowetting surface, and a stable waveform at a fluid interface, can be achieved by applying a DC voltage. With the present approaches, the waveforms generated at fluid interfaces can be inherently unstable, may require feedback control of a voltage that constantly changes with time, and typically cannot be achieved by applying a DC voltage which does not change with time.

In an example, a feedback control configuration is implemented so that a static waveform, such as a standing wave, is generated in the fluids while preventing the complete dewetting of a dielectric or other surface/structure supported by or otherwise carried on the substrate by the non-conductive fluid. Several electrodes may be positioned on a first surface of the substrate so that the several electrodes are positioned between the first surface of the substrate and an insulating fluid, such as oil, and the electrically conductive fluid, such as water. Other conductive fluids include alcohols, glycols, ionic liquids, or other suitable materials that can conduct electrical or ionic charges adequately to enable the electrofluidic operations described below. Conducting fluids may contain salts or other additives to alter their electrical conductivities.

A controller may apply a voltage level based on the capacitance level of the conductive fluid at each electrode. For example, a capacitance level at an upper threshold is indicative that thickness level of the insulating fluid has reached a minimum and that the insulating fluid is close to completely dewetting the dielectric or other surface/structure supported by or otherwise carried on the substrate. A capacitance level at a lower threshold is indicative that the thickness level of the insulating fluid has reached a maximum. The controller may then cause an electrode that has a capacitance level at the upper threshold to decrease the voltage level so that the thickness level of the insulating fluid at that electrode increases. The controller may then cause an electrode that has a capacitance level at the lower threshold to increase the voltage level so that the thickness level of the insulating fluid at that electrode decreases.

As used herein, the term waveform when referring to the insulating fluid may refer to any achievable geometry by broadly using the methods taught herein, which for example can include harmonic, linear, non-linear, corners, convex/concave areas, ripples, non-spherical protrusions or cavities, or other geometries or shapes in any dimension along the meniscus surface of the insulating fluid. For simplicity, in many cases the geometry can be referred to as a wave, waveform, or similar terms, but as described above, should not be interpreted as limited by the plain meaning of the specific word used, such as wave. The figures and their respective diagrams present ‘waves’ which change along one dimension or axis, however, the techniques described herein are not so limited and two dimensional changes in geometries are included as part of the present disclosure, achieved for example by two dimensional arrays of electrodes or other suitable methods. The electrofluidic techniques described may produce arrays of multiple geometries or waveforms that are similar or identical, or two or more waveforms or geometries which are different and impart different optical effects. For example, a prism array, conventionally will steer light passing through it in one direction, a lens array will conventionally diffuse light isotropically; however, an array could also include a prism and a lens, or a prism and differently oriented prism such that multiple optical effects can be achieved simultaneously within the array.

The toggling of the voltage level generated by each electrode from an increased level to a decreased level based on the capacitance level at each electrode generates a static waveform in the insulating fluid and the electrically conductive fluid. The increase in the voltage level decreases the thickness of the insulating fluid which in turn decreases the amplitude of the standing wave. The decrease in the voltage level increases the thickness of the insulating fluid which in turn increases the amplitude of the standing wave. In monitoring the capacitance level relative to each electrode to determine when the thickness level of the insulating fluid has reached a minimum enables the controller to then cause each electrode to decrease the voltage level which then increases the thickness level of the insulating fluid before complete dewetting of a surface of the substrate or a surface of an element or structure carried by the substrate occurs.

In another example, a propagating wave configuration is implemented so that a propagating waveform is generated in the fluids while preventing the complete dewetting of a surface of the substrate or a surface carried by the substrate. Again, the term ‘wave’ may be interpreted broadly to encompass any achievable geometry or shape. The controller may cause each electrode to generate a voltage level that generates a waveform at an amplitude that is related to the voltage level. As the voltage level of a specified electrode is increased, the amplitude of the waveform at that electrode is altered such that the insulating fluid is made thinner. As the voltage level of the specified electrode is decreased, the amplitude of the waveform at that electrode is also altered such that the insulating fluid is made thicker.

The controller may then cause a first electrode to decrease the voltage level for a period of time generating a waveform. After the waveform propagates to the second electrode, the controller may cause the first electrode to increase the voltage level for a second period of time so that the amplitude of the waveform is further altered at the first electrode, and also adjust the voltage at the second electrode. A third or more electrodes can be utilized in this manner. The controller may continue to cause each subsequent electrode to increase or decrease its voltage levels accordingly so that a generated waveform propagates across the substrate while preventing complete dewetting of a surface of the substrate or a surface carried by the substrate.

In the Detailed Description herein, references to “one example” or “an example” etc., indicate that the referenced example may include a particular feature, structure, or characteristic, but every example may not necessarily include the particular feature, structure, or characteristic. Moreover, such phrases are not necessarily referring to the same example. Furthermore, when a particular feature, structure, or characteristic may be described in connection with an example, it may be submitted that it may be within the knowledge of one skilled in the art to affect such feature, structure, or characteristic in connection with other examples whether or not explicitly described.

The following detailed description refers to the accompanying drawings that illustrate several examples. Other examples are possible, and modifications can be made to the examples within the spirit and scope of this description. Those skilled in the art with access to the teachings provided herein will recognize additional modifications, applications, and examples within the scope thereof and additional fields in which examples would be of significant utility. Therefore, the detailed description is not meant to limit the subject matter to the examples described below.

Existing techniques for electronic control of the interface between two immiscible fluids or between a fluid and gas are typically limited to simple periodic (symmetric waves) or spherical geometries (only two principle radii of curvature). A new technique for much more sophisticated control of the geometry of a fluid meniscus is presented below which enables controlled formation of more complex waveforms at the fluid interface. Previously undemonstrated waveforms in two-fluid interfaces, such as asymmetric saw-tooth profiles, are created by dynamic modulation, for example, of an incomplete dewetting state for an oil film covering an array of control electrodes, with the oil film itself covered by an electrically conductive fluid acting as the ground electrode. The two approaches described below and shown in the drawings are electro-hydrodynamically modeled by coupling the Maxwell stress tensor with the laminar phase field of the oil-water dual phase: (1) application of voltages, electrical capacitance based sensing of meniscus geometry, followed by further feedback control of the applied voltages based on measured electrical capacitance; or (2) use of multiple periodic voltage waveforms and wave propagation across the meniscus to build up complex meniscus geometries by Fourier construction. Such techniques could be useful for applications such as particle or fluid transport (e.g. lab-on-chip) or adaptive optical surfaces (e.g. liquid lenses or prism arrays). However, the improved results can be achieved using conventional materials, and the fluids respond with speeds that are adequately slow (ms-μs) such that even conventional control electronics (μs-ns) are more than adequate for implementing the new control strategies.

Electronic control of the geometry or transport of a fluid meniscus using dielectrophoresis or electrowetting is now a fairly mature field, even resulting in commercial products ranging from liquid lenses (Varioptic) to lab-on-chip devices (Illumina/Advanced Liquid Logic). The functional demonstrations are numerous and diverse, including droplet transport and mixing, tunable lenses, tiltable prism arrays, displays, diffraction gratings, and pixel-free optical shutters. However, these applications generally have in common several fundamental restrictions: (1) many, in practice, are limited to a spherical meniscus geometry (two principle radii of curvature); (2) some are non-spherical, but providing only periodic and symmetric features; or (3) most are restricted to equilibrium profiles where the insulating fluid (typically an oil) is fully dewetted from at least a portion of an electrically charged surface, requiring a contact angle change for the conducting fluid on an adjacent solid surface on which the electrowetting takes place.

As a result, more sophisticated meniscus geometries, such as approximated saw-tooth or square-wave profiles, have not been demonstrated. These types of fluid profiles could open up new opportunities in optics, such as phased arrays for beam steering, and could enable new forms of particle or fluid transport for lab-on-a-chip applications.

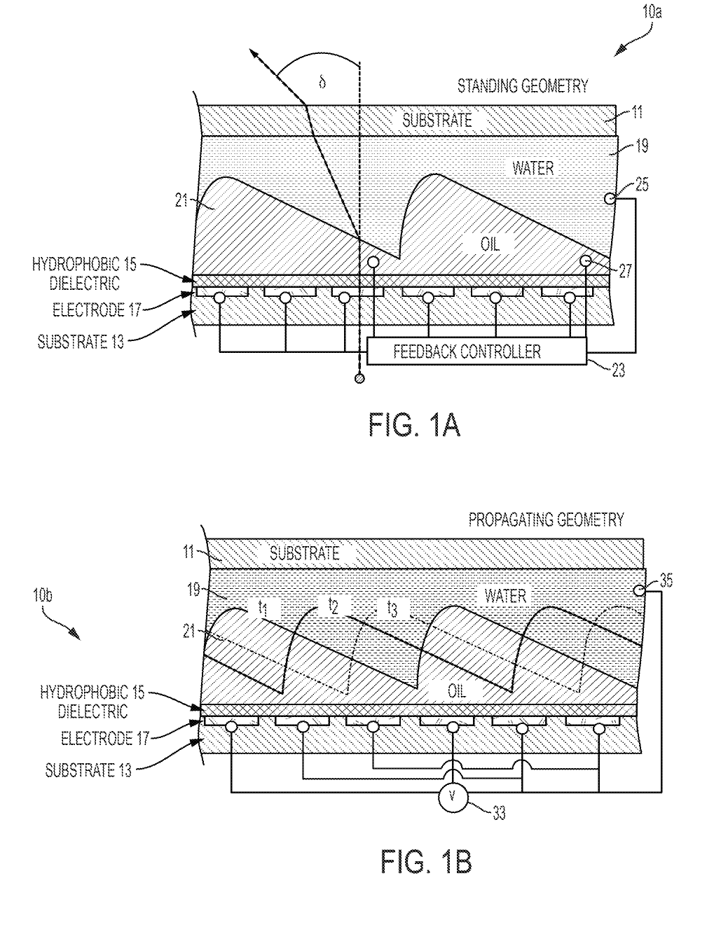

Geometries for two-fluid interfaces, such as asymmetric saw-tooth profiles, are created by dynamic modulation of an incomplete dewetting state for an oil film covering an array of control electrodes and covered itself by an electrically conductive fluid (see FIGS. 1A and 1B). Two electrodynamic methods are explored: (1) application of voltages, electrical capacitance based sensing of meniscus geometry, followed by further feedback control of the applied voltages based on electrical capacitance (see FIG. 1A); and (2) use of multiple periodic voltage waveforms and wave propagation across the meniscus to build up complex meniscus geometries by Fourier construction (see FIG. 1B). Both of these techniques enable partial wetting of the oil film, for example, well past the conventional point of instability for complete oil film breakup. Several demonstrations are provided by numerical modeling, in which the electro-hydrodynamic (EHD) force deduced from the Maxwell stress tensor is coupled with the laminar phase field of the oil-water dual phase. The results can be achieved using conventional materials, and the fluids respond with speeds that are adequately slow (ms-μs) such that even conventional control electronics (μs-ns) are more than adequate for potential applications at an interface between the first and second fluids. These results can be achieved without requiring a contact angle change for the conducting fluid on an adjacent solid surface from which the applied electric fields originate. In an example using a dielectric, since dewetting of the dielectric on the electrodes/substrate by the non-conductive fluid may be prevented, the conductive fluid does not reach/wet the dielectric or have/change a contact angle at the surface of that dielectric. As a result, the complex waveforms generated at the fluid interface can be inherently unstable, may use feedback control of a voltage that constantly changes with time or vary over time to produce a propagating wave. Such complex and/or dynamic wave geometries cannot be achieved by applying a DC voltage which does not change with time. The feedback control voltage can also be small enough in changing magnitude or rapid enough, such that an apparent static geometry is created (although as noted above, even though it is static such a geometry can be inherently unstable as well).

FIG. 1A depicts a configuration of a multi-fluid device 10a that implements a feedback approach in generating complex waveforms in the fluid interface geometry, e.g. while preventing complete dewetting. FIG. 1B depicts a configuration of a multi-fluid device 10b that implements a propagating wave approach to waveform generation, e.g. while preventing complete dewetting. In both approaches, the multi-fluid system includes a first or bottom substrate 13, a second or top substrate 11 and in these examples an array of patterned electrodes 17. The electrodes 17 are adjacent to the substrate 13, e.g supported by the substrate directly or by some intermediate layer on the substrate. In alternate examples, electrodes 17 could be non-repeating or non-arrayed, with the only requirement being that there is at least one electrode. In these illustrated examples, a dielectric covers the electrodes 17 and any exposed portions of the surface of the substrate 11. In the examples, the dielectric is a hydrophobic dielectric 15 layer, although separate hydrophobic and dielectric layers may be used. Alternately, the dielectric need not be electrically insulating. Alternately, no coating or film could be needed at all, so long as similar wetting properties are achieved as taught in subsequent paragraphs of this specification. The substrates 11, 13 may be formed of glass or other suitable material. For ease of illustration, the electrodes 17 are shown as if formed in grooves etched into the surface of the substrate 13, and electrical connections to the electrodes 17 are shown passing through the substrate 13 (as if in vias formed in the substrate). Alternatively, the electrodes and/or leads may be formed on a relatively flat surface of the substrate 13.

The devices 10a, 10b utilize a conducting fluid and an insulating fluid, for which there are numerous options, but the following discussion will be relative to be an electrically conductive water phase 19 (second fluid) and insulating dodecane oil phase 21 (first fluid). In these examples, the volume formed between substrates 11 and 13 is at least substantially filled by the fluids 19 and 21. The fluids may completely fill the volume as shown; or there may be a gas or another fluid within the volume. The oil 21 is nearest or adjacent to the dielectric 15, electrodes 17, and supporting first substrate 13. The water 19 is further from (separated by the fluid 21 from) the dielectric 15 and substrate 13. The water 19 instead is near the second substrate 11, with the oil 21 between the water and the dielectric 15.

Unlike conventional electrowetting, the hydrophobic dielectric 15 in the examples does not need to sustain the full applied voltage, as the oil film 21 never allows the conducting fluid 19 to fully wet through the oil film 21 (only partial oil film dewetting). Therefore the hydrophobic dielectric 15 is simply one that has an interfacial tension with the surface of dielectric layer 15 that is low enough to promote a Young's angle θ_{Y} of 180°. Uniform oil film height could be achieved by the electronic control methods that will be taught herein, or by use of an array of hydrophobic pillars (not shown), which could pin the oil height. Many of the aging issues with conventional electrowetting (dielectric degradation) may not be an issue for such devices 10a, 10b as the water phase 19 never comes in contact with the solid dielectric 15 and the system dielectric is mainly the oil 21, which is a fluid and inherently self-healing in terms of electrical defects. The full set of parameters for all materials relevant to the modeling results can be found in Table 1.

An electrode 25 provides electrical connection to the water phase 19. The electrode 25 may stand alone as shown or be implemented as a plate in or on the surface of the substrate 11 adjacent to the water. The apparatus of FIG. 1A also includes one or more sense electrodes 27. The device 10a of FIG. 1A uses the feedback control method, referred to herein as the ‘feedback method’ implemented by appropriate configuration of a feedback controller 23. The feedback controller 23 may be implemented with a controllable multi-output voltage source to provide respective selected voltages to the electrodes 17, a capacitance measurement circuit for measurement of capacitance between a sense electrode 27 and water 19 which is electrically conductive with electrode 25, as well as an appropriate high-level logic circuit. The high level logic may be a hardwired circuit or may be implemented by a programmable processor based device such as a microcontroller or a microprocessor. Alternately, the controller 23 could use any method suitable for feedback control, for example analog electronics feedback control circuitry. Alternately, electrodes 17 could provide both voltages and sense electrical capacitance between electrodes 17 and water 19, and electrodes 27 could be removed. Alternately, the feedback controller 23 could be fabricated on the substrate 13, using fabrication techniques such as silicon microfabrication on silicon or active-matrix transistor fabrication on glass.

The feedback method uses application of voltages even possibly beyond the point of stability for a complete oil film 21, electrical capacitance based sensing of meniscus geometry, followed by further feedback control of the applied voltages based on electrical capacitance, to maintain an oil film geometry where the water 19 never reaches the surface of the hydrophobic dielectric 15. As outlined above, the two fluids 19, 21 have different electrical properties (conductive and non-conductive/insulating). For transmissive type optical applications the two fluids 19, 21 also are different in refractive index. For example, the conductive water 19 may have a lower index of refraction than the non-conductive oil 21. Different optical effects could be enabled by feedback control of applied voltage from the controller 23.

The example of a wave in FIG. 1A, is that of a saw-tooth profile which could be utilized as a Fresnel lens or phased array (see arrow example of optical ray trace) in an optical implementation of device 10a. Other geometries, such as a triangle wave, square wave, half-wave, etc. are likely possible, including non-periodic geometries, if adequate electrodes and controls are implemented.

In such a feedback example, the controller 23 may be configured to measure the capacitance level at each electrode 17 supported by the first substrate 13 to determine when the capacitance level is at an upper threshold for a period of time; and decrease the voltage level of each corresponding electrode 17 adjacent to the first substrate when the capacitance level is at the upper threshold indicating that the thickness level of the first fluid 21 has reached a minimum. The decrease in the voltage level when the capacitance level is at the upper threshold increases the thickness level of the first fluid 21, for example, to prevent complete dewetting by the second fluid. The feedback controller 23 may be further configured to measure the capacitance level at each electrode 17 to determine when the capacitance level is at a lower threshold for the period of time and increase the voltage level of each corresponding electrode 17 when the capacitance level is at the lower threshold indicating that the thickness level of the second fluid has reached a maximum. This increase in the voltage level when the capacitance level is at the lower threshold decreases the thickness level of the first fluid 21. The terms ‘maximum’ and ‘minimum’, when referring to voltages, capacitances, or thickness of fluids, or other aspects of the present disclosure, can refer to absolute maxima or minima (e.g. physical limits) or maxima or minima that are measured, defined, or determined (e.g. set or determined by a feedback controller).

The device 10b of FIG. 1B creates propagating waves in the oil 21 and in some cases superposition of multiple created waves of different frequencies (Fourier construction), referred to herein as the ‘wave method’. The ‘wave method’ uses multiple periodic voltage waveforms to generate the wave frequencies and the geometries resulting from superposition.

An electrode 35 provides electrical connection to the water phase 19. The electrode 35 may stand alone as shown or be implemented as a plate in or on the surface of the substrate 11 adjacent to the water. The ‘wave method’ may be implemented by appropriate configuration of a voltage (V) controller 33. The voltage controller 33 may be implemented with a controllable multi-output voltage source to provide respective selected voltages to the electrodes 17 and appropriate high-level logic circuit. The high level logic may be a hardwired circuit or may be implemented by a programmable processor based device such as a microcontroller or a microprocessor. As in the example of FIG. 1A, the two fluids 19, 21 are different in refractive index.

For example, the voltage the controller 33 may be configured to adjust the voltage level of each electrode 17 from a maximum voltage level to a minimum voltage level after the waveform generated by each respective electrode 17 reaches each succeeding electrode. The controller 33 may also adjust the voltage level of each electrode 17 from the minimum voltage level to the maximum voltage level when the waveform generated by each respective preceding electrode reaches each succeeding electrode. The adjustment of the voltage level of each electrode 17 between the maximum voltage level and the minimum voltage level generates the propagating waveform while preventing the complete dewetting of the dielectric by the second fluid.

Before delving into the specific results, several additional points are briefly discussed. Both the feedback method and wave method will be discussed in detail, however, these two methods could also be combined (wave propagation, Fourier construction, and feedback control. Also, the feedback method shown in FIG. 1A will create geometries that appear static (although feedback control is inherently dynamic), whereas the wave method will create geometries that will move horizontally with time.

FIG. 1A depicts an example of using the feedback method to build up a saw-tooth profile, for example, for use as a Fresnel lens or phased array. The arrow example of an optical ray trace shows refraction from a perpendicular ray input direction, where δ denotes the optical steering angle. FIG. 1B depicts an example of using multiple periodic voltage waveforms and wave propagation across the oil meniscus to build up complex meniscus geometries by Fourier construction. For example, in FIG. 1B, t₁<t₂<t₃. The illustrated feedback method may create geometries that appear static (although feedback control is inherently dynamic), whereas the wave method (b) may create geometries that will move horizontally with time.

The horizontal orientations shown are given by way of example only.

The modeling results begin with exploration of the limit of oil film stability against dewetting. These results reveal that feedback control may be useful if substantial slopes or curvatures are to be implemented onto the meniscus of the oil film 21 at the interface with the water 19. The setup includes a 5-μm oil film 21 covering on a 1-μm hydrophobic dielectric layer 15 with electrode width wₑ=25 μm and gap width between electrodes 17 of width w_{g}=25 μm.

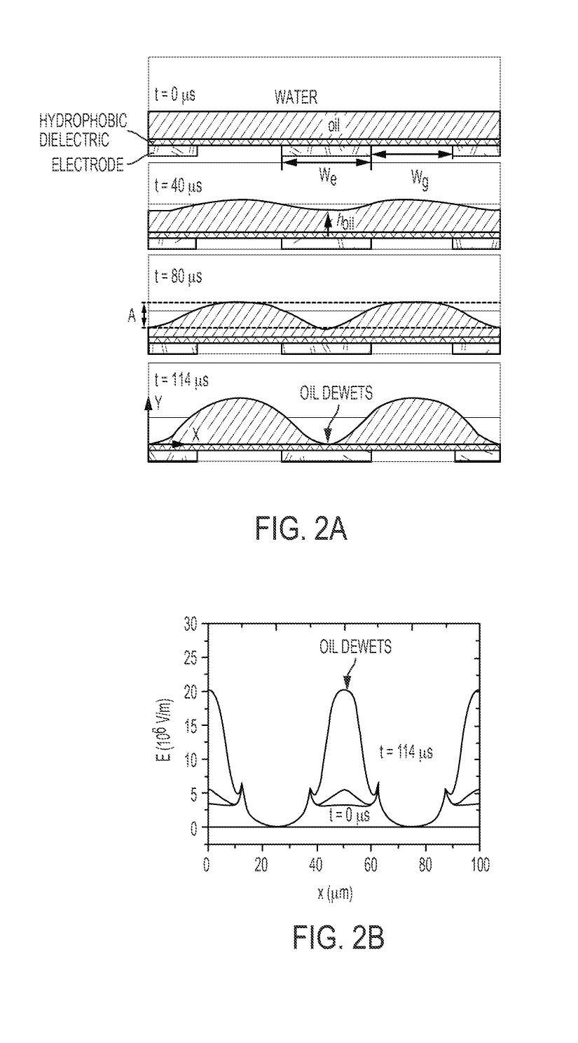

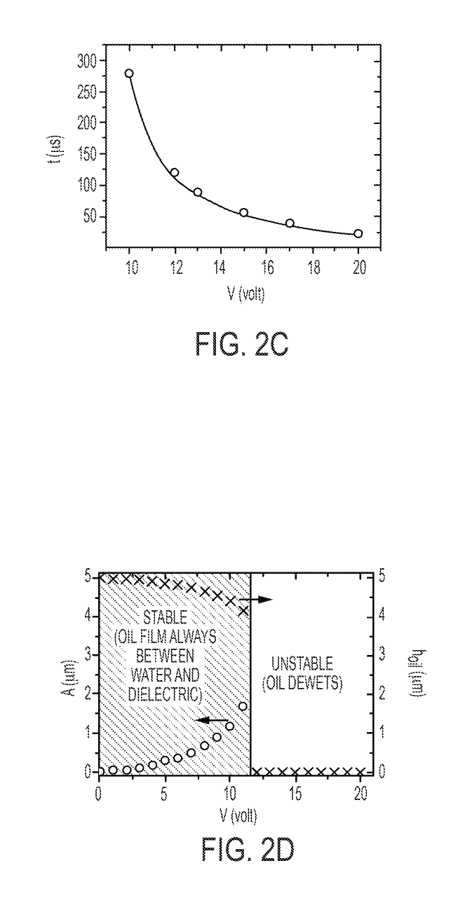

First, the time evolution of the dewetting process for the oil 21 under an abruptly applied 20 V is shown in FIG. 2A, from which the water phase 19 fully wets through the oil phase 21 to the hydrophobic dielectric 15 at t=114 μs. Unlike the instabilities for complete oil film breakup with a large planar electrode the patterned electrodes 17 themselves determine the periodic profile surface at the oil-water fluid interface. FIG. 2B provides the corresponding electric field strength calculated at the surface of the dielectric layer 15 from x=0 to 100 μm during the dewetting process from t=0 to 114 μs. At the position where the water 19 has fully wetted the hydrophobic surface (oil 21 fully dewetted), the difference of electric potential across the hydrophobic dielectric layer is approximately equal to the external applied voltage (i.e., V=E_{hyd}d_{hyd}).

Next, as shown in FIG. 2C, the fluid dewetting speed is parametrically analyzed. As shown in FIG. 2C, the time requirement is measured for the oil surface to reach the wave amplitude A=1 μm with different applied voltages when A=0 μm for a 5-μm oil film (see FIG. 2A for a labeling of A). It is confirmed that switching speeds of fluids that are adequately slow (ms-μs), such that even conventional control electronics (μs-ns), will be more than adequate for feedback control. Easily, more viscous oils could be utilized to slow the dewetting speeds and to more rapidly dampen disturbances on the oil meniscus.

Lastly, as shown in FIG. 2D, the amplitude A and local oil height hₒᵢₗ are recorded as voltage is increased from 0 to 11 V. The data shows that stable sinusoidal profiles can be generated for A from 0 to 1.7 μm with corresponding minima for hₒᵢₗ from 5 to 4.15 μm could be created. When the applied voltage is beyond ˜11 V, the electrostatically induced oil film breakup occurs, thus leading to a periodic breakup into the space between the patterned electrodes. The fact that only a small change can be achieved for oil film thickness (4.15˜5 μm) confirms that feedback control may be appropriate if greater changes in oil film height are to be maintained.

FIG. 2A depicts time evolution of the oil film dewetting process with 20 V applied at t=0. Here, A denotes the amplitude of the wave profile; and hₒᵢₗ is the oil film height minima directly above the center of an electrode to which the feedback controller applies an appropriate voltage. FIG. 2B depicts the electric field calculated at the surface of the dielectric layer 15 during the dewetting process corresponding to the evolving states shown in FIG. 2A. FIG. 2C depicts the time requirement for the periodic wave profile taken to reach A=1 μm with different applied voltages. FIG. 2D depicts a plot of amplitude A and oil film minima hₒᵢₗ with different applied voltages. When the applied voltage is beyond ˜11 V, the oil film 21 is unstable and the water 19 reaches the dielectric surface.

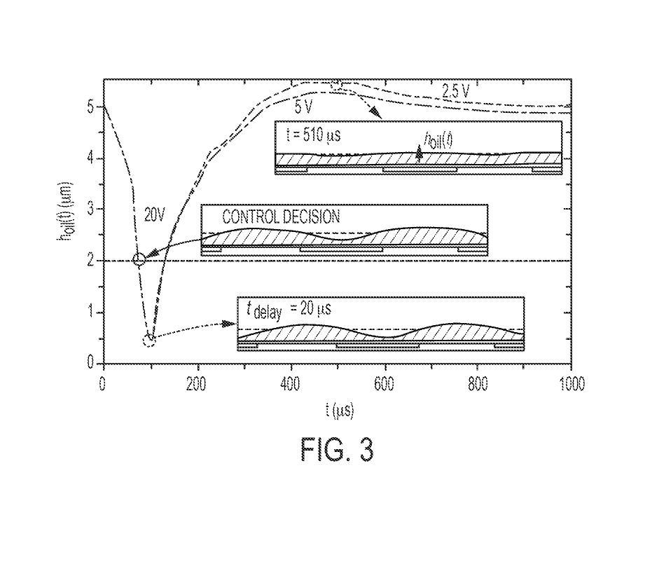

FIG. 3 shows the results of a simple control decision to avoid complete dewetting of the oil film 21 from the dielectric 15, where the parameters used here are identical to those of FIG. 2A. A control decision is created for when the oil film 21 reaches a thickness of hₒᵢₗ(t)=2 μm, which is well beyond the point of stability illustrated in FIG. 2D. Such control decision could be easily sensed by measurement of electrical capacitance between the water 19 and the particular electrode 17. In this example, the electrode sensing capacitance and applying voltage are one and the same. For example, the feedback controller 23 may be configured to take a capacitance measurement between a selected one of the electrodes 17 and a conducting fluid 19 contacted by electrode 25, then process the measured capacitance and the level of voltage applied to that particular electrode 17 to determine a measure of capacitance between the conducting fluid 19 and that particular electrode 17. Since thickness of the dielectric 15 is fixed in the vicinity of the electrode 17, variations in the measured capacitance correspond to variations in thickness of the non-conductive oil 21. The controller then bases a decision regarding any further adjustment of the voltage to apply to the particular electrode 17 on the measure of capacitance (corresponding to oil thickness), e.g. based on relationship of the measure of capacitance to one or more threshold values. No decision occurs infinitely fast, so in this example, an ‘electronics control’ delay time of 20 μs is inserted into the simulation before the voltage is decreased to 5V to prevent complete oil dewetting. As shown in FIG. 3, the oil film recovers. It should be noted that the higher voltages in FIG. 2D in the range of the stable state, such as 10 V, cannot be used because at the decision point the oil film minima is already much thinner and the electromechanical force (electric field) will be too large. This feedback method is not continuous (looping), which is the topic that will be addressed next. As noted above, in this example, the electrode 17 used sensing capacitance and applying voltage are one and the same. However, in an alternate feedback implementation, they need not necessarily be the same. For example, an first electrode of electrodes 17 could be dedicated to applying voltage and another distinct electrode of electrodes 17 could be dedicated to sensing electrical capacitance, with the primary requirement that the particular electrodes 17 be near enough to each other. In a specific example, the space between such distinct electrodes 17 would be less that the maximum thickness of the insulating fluid (oil 21) between them. This clearly shows that the present feedback technique (e.g. the device 10a of FIG. 1A) is not limited to a particular scale, but that dimensions and geometries are interrelated and in most cases scale together as they get larger or smaller.

FIG. 3 depicts the plot of the time evolution of the oil film thickness with the control decision at an oil height of 20 μm to reduce the applied voltage from 20V to 5V. A 20 μs delay in implementation of the decision is included to mimic the delay associated with feedback control electronics 23, which would sense oil film height through electrical capacitance between the water 19 and one of the electrodes 17.

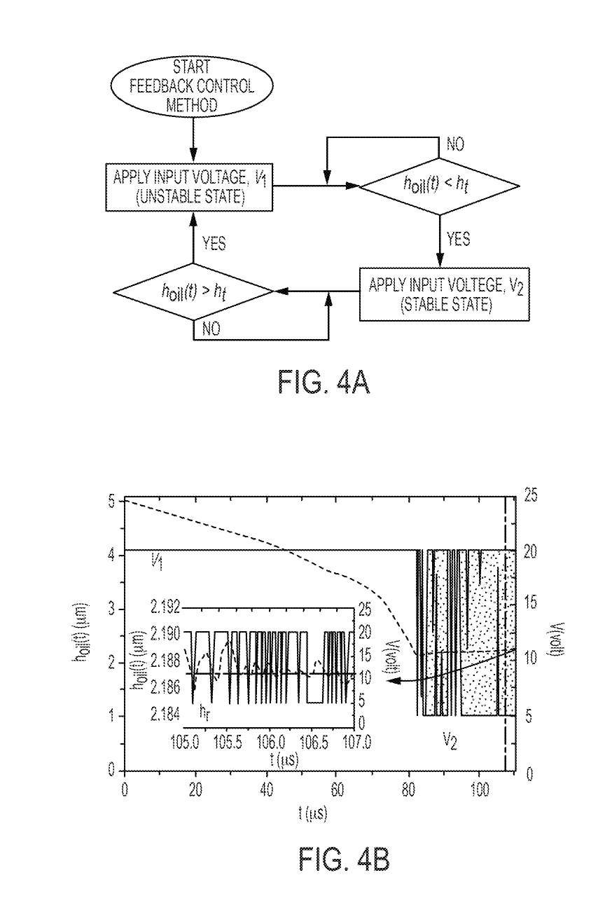

The basic decision shown in FIG. 4A applies to one electrode 17 or use individually with multiple electrodes 17. First, a relatively high voltage V₁ (beyond point of oil film stability) is applied until the oil thickness hₒᵢₗ(t) (measured in the model as electric field magnitude) reaches the final expected value h_{f} (or E_{f}). Next, the applied voltage is switched to V₂, which is below the point of stability. Then, as hₒᵢₗ(t) becomes larger than h_{f}, the applied voltage is switched back to V₁ again, increasing the electromechanical pressure and the oil phase 21 once again reverses in direction. Consequently, throughout the looping feedback method, the oil phase 21 oscillates itself around the targeted height h_{f}. The amplitude of oscillation can be quite small if the delay time for the decision is small and the fluid exhibits viscous damping.

FIG. 4B shows a feedback method example that anticipates oil thickness beyond the critical point of instability. The parameters used in this example are the same as those in FIG. 4A. In this case, the delay time in the simulations is ignored since the time step (˜10⁻⁸ s) adopted in the numerical calculation is smaller than time delay of the electronic sensors (˜10⁻⁹ s). First applied is a relatively high voltage V₁=20 V, in which the oil may be fully dewetted without feedback control. When the local oil height is smaller than the designated value (in this case h_{f} is 2.187 μm) the applied voltage is switched to V₂=5 V. Once hₒᵢₗ(t) is larger than h_{f}, the input voltage is then switched back to V₁, and so on . . . . In total, this version of feedback control only required ˜80 μs to achieve the final oil film height. This feedback control process will be implemented repeatedly to maintain hₒᵢₗ(t) at the designated point h_{f} as shown in the inset of FIG. 4B.

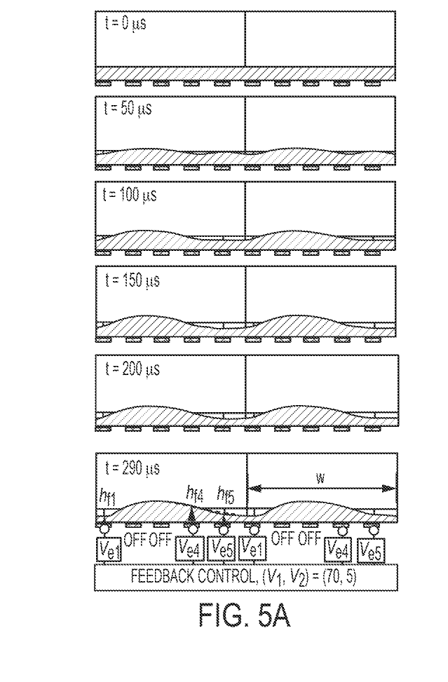

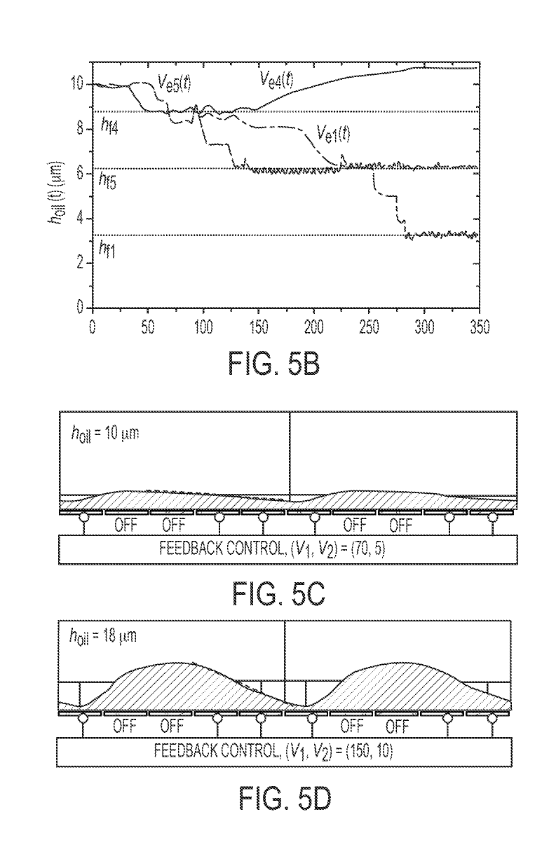

Next, multi-electrode control is demonstrated in order to build up more sophisticated asymmetric profiles. In this example, each electrode 17 has its own voltage source and feedback control (implemented in controller 23), and is given a localized oil film height roughly expected to create the desired geometry. Again, electrical capacitance could be the technique used to quickly measure the oil film height at any time. The example may involve reducing the width of electrode and/or increasing the oil film thickness. To this end, the demonstrated example utilizes a 10-μm oil film on patterned electrodes with wₑ=w_{g}=10 μm. As seen in FIG. 5A, the simulation results show that an asymmetric triangular profile is created in only t=290 μs after starting from an initially flat oil film (t=0 μs).

In this example, one triangular profile is controlled by five electrodes, where the feedback method is implemented with (V₁, V₂)=(70 V, 5 V) at the first, fourth and fifth electrodes, and the second and third electrodes are switched off. The feedback control response of the oil film thickness over the three actuated electrodes is plotted as a function of time in FIG. 5B (again, corresponding to the time-lapse photographs in FIG. 5A). Not surprisingly, the electrode which requires the longest time (the full 290 μs) to stabilize oil height above it is the one which must create the thinnest oil film height. A longer settling time may be due to: (1) a thinner the oil film height that requires the larger change from the initial oil film height; or (2) the thinner the final the oil layer, the more difficult it is to control (less stable, stronger electric fields and meniscus velocities).

In an additional demonstration, asymmetric profiles were investigated with smaller gap width between the electrodes (FIGS. 5C and 5D). Here the array of patterned electrodes of wₑ=25 μm and w_{g}=2 μm using feedback control for: FIG. 5C (V₁, V₂)=(50 V, 5 V) for dₒᵢₗ=10 μm, and; FIG. 5D (V₁, V₂)=(150 V, 10 V) for dₒᵢₗ=18 μm. For applications such as beam steering, the thicker the oil film the greater the steering angle δ that could be created. However, thicker oil films will require higher voltages for control. Of course, interfacial tension between the oil and water could be reduced, lowering the required voltage, but likely requiring longer times before the final oil geometry can be stabilized. It is fully expected that much more triangular shapes for the fluids are achievable.

FIG. 4A depicts a flow chart (decision loop) of the feedback method. FIG. 4B depicts a plot of the of the oil film thickness hₒᵢₗ(t) as a function of time with the feedback method. The inset shows the very small oscillation of the oil film height around the targeted thickness for t>100 μs.

FIG. 5A depicts an asymmetric triangular profile (t=290 μs) that is created from the initially flat oil film (t=0 μs) based on the feedback method. FIG. 5B depicts the plot of the of the oil film thickness hₒᵢₗ(t) above the three actuated electrodes as a function of time. FIGS. 5C and 5D depict plots of the fluid film profile with hₒᵢₗ=10 and 20 μm and an reduced gap width between electrodes.

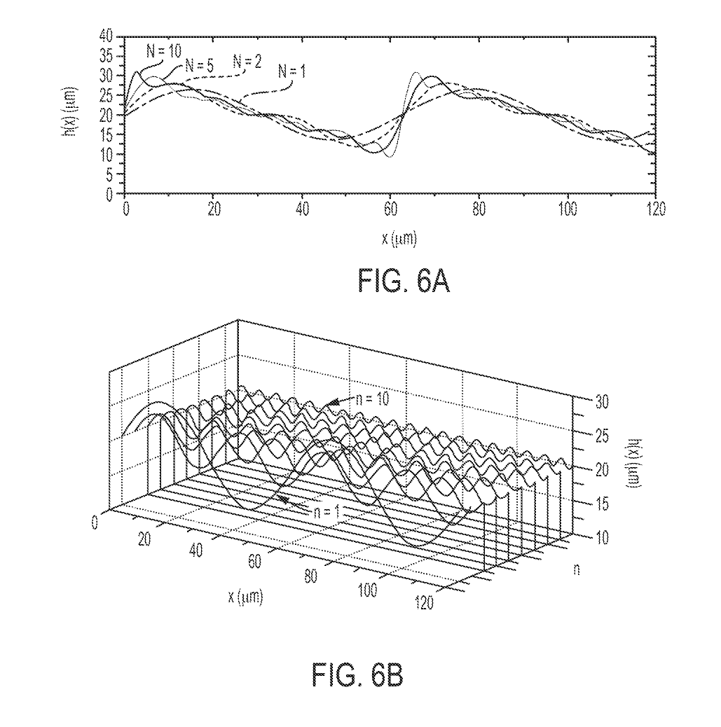

In the wave method, multiple periodic undulations of the oil (waves) are created and super-imposed to Fourier construct complex shapes (FIG. 6). This complicates the overall control, but in theory can provide even finer control over the oil film geometry (steeper slopes, sharper corners). Propagating waves may utilize low-viscosity fluids, however, such that viscous damping does not quickly diminish the wave.

The oil height h(x) of saw-tooth wave in a Fourier series approximation based on initial oil thickness hₒᵢₗ can be expressed as:

$$h ( x ) = {h}_{oil} + \frac{{h}_{oil}}{π} {\sum }_{n = 1}^{N} sin ( \frac{nx}{10} ) / n . \qquad ( 1 )$$

where N is total modes (or electrodes). An ideal wave theory (not with fluids) example is plotted in FIG. 6. As N increases, the fidelity of the sawtooth geometry increases.

FIG. 6A depicts approximately saw-tooth profiles h(x) according to the Fourier series approximation for N=1, 2, 5, and 10. FIG. 6B depicts the first 10 basis functions.

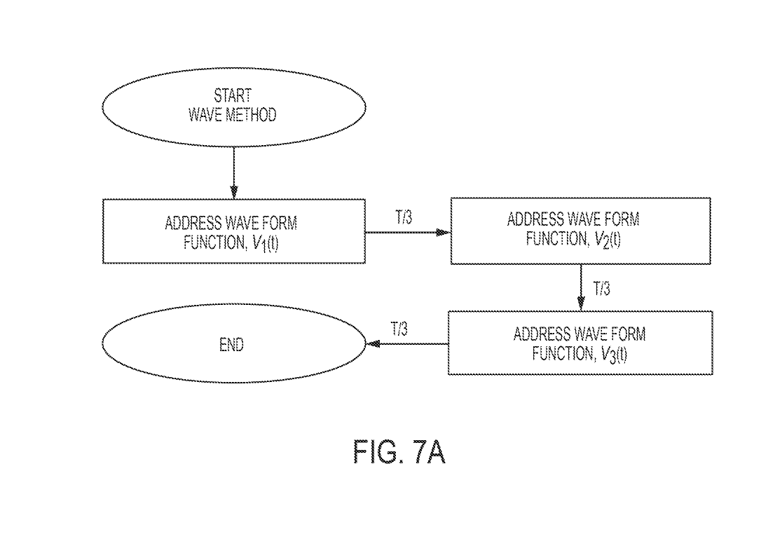

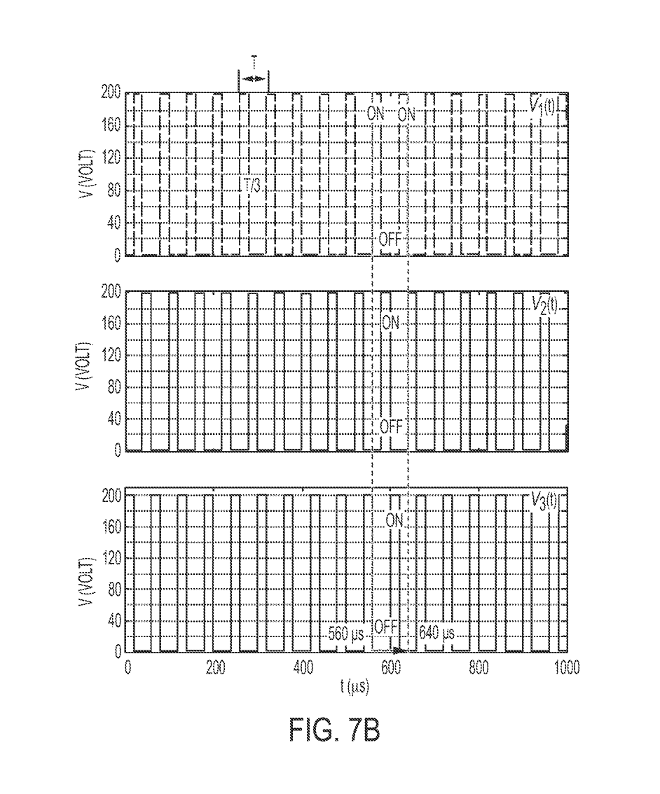

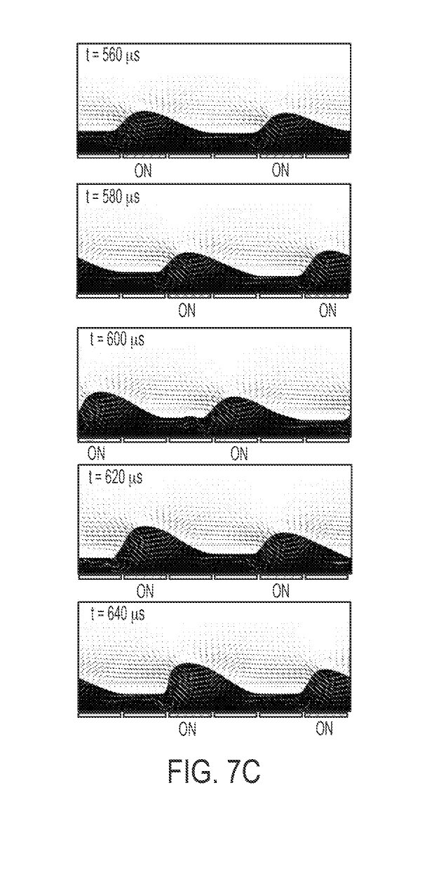

FIG. 7A shows the steps in a process of using the wave method for generating wave propagation and creating complex geometries, such as a sawtooth profile. Three driving waveforms V₁(t), V₂(t), and V₃(t) with T/3 duty cycle are controlled to oscillate the fluids and to create or support fluid flow, where T is the time of a complete cycle as shown in FIG. 7B. The fact that the fluid is flowing is further interesting, indicating that this technique also may be useful for lab-on-chip type applications involving fluid flow. The parameters used for FIGS. 7A to 7C are the same as those in FIG. 4D, and the amplitude and the time per complete cycle of the waveforms function is 200V and 60 μs, respectively. FIG. 7B is a non-limiting example of providing a sequence of voltages to a plurality of electrodes to enable a propagating waveform.

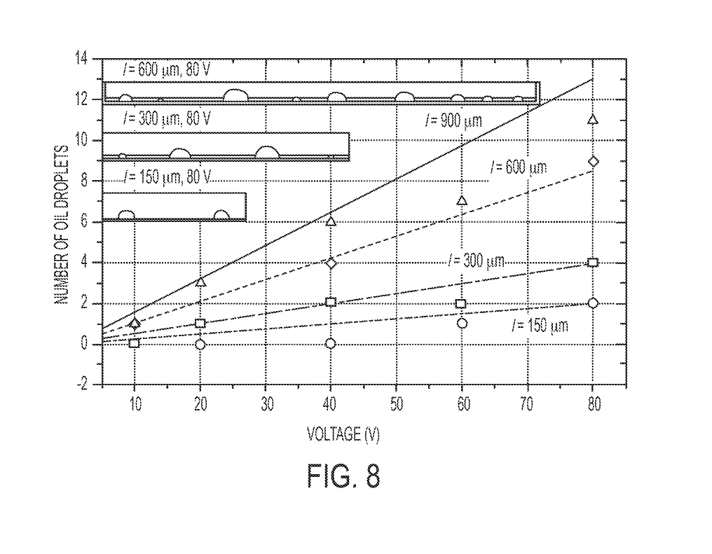

FIG. 7C shows the simulation result of wave propagation from t=560 to t=640 μs, where triangular profiles are created. At t=560 μs, for example, the waveforms of V₁(t) is switched on in order to drive the wave to propagate to next electrode. After 20 μs (T/3), when the wave arrives at the next electrode, V₂(t) is switched ON and V₁(t) is switched OFF. As a result, the continuous wave propagation with triangular shape could be generated as seen in simulated pictures in FIG. 7C. The velocity field of oil (green arrows) and water (red arrows) is plotted in FIG. 8. As shown, the water phase near the triangular oil waves flows along the direction of wave propagation. This demonstration assumed an infinite region of water above the oil, and obviously the flow patterns would be affected if a finite channel height existed (e.g. like that shown in FIG. 1B).

FIG. 7A depicts a flow chart of the wave method. First, is V₁(t). Then, come V₂(t) and V₃(t) after T/3 and 2T/3, respectively. FIG. 7B depicts three different driving waveforms V₁(t), V₂(t), and V₃(t) with T/3 duty cycle addressed across the fluids. FIG. 7C depicts simulated wave propagation using wave method from t=560 to t=640 μs, where the triangular profiles are created. The green and red arrows denote the velocity field of oil and water, respectively.

For applications where the ˜100 μs switching speeds demonstrated herein are not needed, fluid interfacial surface tensions can be reduced to 0.1's to 1's of mN/m and voltages reduce to the point where Si control circuitry can be readily used along with high-density electrodes. Other interesting possibilities include reflective fluid interfaces, enabled by Janus particles or thin flexible films. The key outcome of this work, is stimulate different thought of wetting control compared to how it has been dominantly performed in the past. In conventional methods, an equilibrium stimulus is applied and a one or two fluid system allowed to reach equilibrium. This typically results in symmetric or periodic film geometries. In this work, a wider array of geometries are possible. Furthermore, the net fluid flow is interesting because the ‘pumping mechanism’ is localized, which can increase the velocity of fluid flow compared to techniques like electrowetting where the force is limited to the advancing edge of the fluid. In addition, this work opens up interesting opportunities in controlling a fluid meniscus irrespective of the influence of a triple point (contact line), as the water never touches the dielectric surface to form a triple point. Furthermore, from an applied perspective, the fact that the conducting fluid never has to touch the electrode or dielectric may result in extreme longevity for the devices. A wide range of new theoretical and applied investigations are possible, with further development of the feedback and wave methods.

During the dewetting process, many possible dewetting modes for a dielectric oil film grow at different exponential rates. The wave number (q) of the modes that grows fastest can be obtained according to

$$\begin{matrix}{q}^{2} = \frac{H}{4 π {d}_{oil}^{4} {γ}_{OW}} + \frac{{ɛ}_{eq} {V}^{2}}{2 {d}_{eq}^{3} {γ}_{OW}} & ( 2 a ) \\ λ = 2 π / q & ( 2 b )\end{matrix}$$

where λ is the wavelength, H is the Hamaker constant for the dielectric oil film, γ_{ow} is the interfacial tension between oil and water, V is the applied voltage, and d_{eq} and ∈_{eq} are the total equivalent thickness and permittivity of the series capacitance of the oil film (dₒᵢₗ, ∈ₒᵢₗ) and hydrophobic dielectric (d_{hyd}, ∈_{hyd}).

The moving interface between oil and water is set as a tiny nonzero-thickness transition region. Thus, the physical properties at the interface could be described by functions within this region with the use of a continuous phase-field variable φ, which varies from −1 for water to 1 for oil. From the introduced volumetric fractions V̅_{water}=(1-φ)/2 and V̅ₒᵢₗ=(1+φ)/2, the physical quantities within the transition region are given as

ρ=ρ_{water}V̅_{water}+ρₒᵢₗV̅ₒᵢₗ

μ=μ_{water}V̅_{water}+μₒᵢₗV̅ₒᵢₗ

∈=∈_{water}V̅_{water}+∈ₒᵢₗV̅ₒᵢₗ (3)

where ρ, μ, and ∈ represent the density, viscosity, and dielectric constant of fluids, respectively. In the diffusive-interface picture, the evolution of the interface between oil and water is governed by the Cahn-Hilliard convection equation

$$\frac{\partial φ}{\partial t} + u \cdot ∇ φ = ∇ \cdot ( M ∇ G ) , \qquad ( 4 )$$

where u represents the fluid velocity, M denotes the mobility (or diffusion coefficient), and G is the chemical potential. The mobility can be expressed as M=χh_{PF}², where χ is the characteristic mobility and h_{PF} is the capillary width that scales with the thickness of the diffuse interface in PFM. The chemical potential, which is a partial differential of the total free energy with respect to φ, could be expressed as G=η[−∇²φ+φ(φ²−1)/h_{PF}²], where η is the energy density parameter. In addition, η and h_{PF} are related to the oil-water interfacial tension through the relation: γ_{ow}=2\sqrt{2}λ/3h_{PF}.

The static electric field in the hydrophobic dielectric layer, oil phase, and water phase, is assumed to be governed by the Laplace equation:

∇·(∈₀∈ᵣ∇V)=0, (5)

where ∈₀ is the vacuum permittivity, ∈ᵣ is the relative permittivity of the numerical domains including both solid dielectrics and fluids, and V is the electric potential. Here, it should be noted that the assumption of leaky dielectric (no electric charge density) in equation (5) is adopted to help simplify the electrostatic equation of the water phase.

The transport of mass and momentum governed by the incompressible Navier-Stokes equations:

$$\begin{matrix}ρ ( \frac{\partial u}{\partial t} + u \cdot ∇ u ) = - ∇ p + ∇ \cdot μ ( ∇ u + ∇ {u}^{T} ) + {F}_{S} + {F}_{E} , & ( 6 a ) \\ ∇ \cdot u = 0 , & ( 6 b )\end{matrix}$$

where ρ and μ are the density and viscosity of the fluids, which take the form as in equation (2). p, F_{S}, F_{E} respectively denote the pressure, the volumetric surface tension, and the volumetric electrodynamic force generated by an electric field. In the PFM, F_{S} can be calculated over the computational domain in terms of the chemical potential and phase-field variable by

F_{S}=G∇φ. (7).

Obviously, F_{S} approaches zero except those at the diffusive thickness of the oil-water interface. The volumetric electrodynamic force F_{E} a net effect of an applied electric field acting on the fluids, can be expressed by the divergence of the Maxwell stress tensor T^{M}

F_{E}=∇·T^{M}. (8)

In component expression, Tᵢⱼ^{M} is written as:

$${T}_{ij}^{M} = ɛ {E}_{i} {E}_{j} - \frac{ɛ}{2} {δ}_{ij} {E}_{k} {E}_{k} , \qquad ( 9 )$$

where δᵢⱼ is the Kronecker delta function, and i, j=x, y, z.

In the formulation of PFM, the boundary conditions for the hydrophobic surface and top substrate are considered as wetted walls, and along the surfaces we specify a wetted contact angle θ_{w}, which is related to φ through:

n·∇φ=cos θ_{w}|∇φ|, (10)

where n is the unit vector normal to the wall. In addition, the no-slip boundary condition (i.e., u=0) is used to associate with the momentum equation (6). Furthermore, the periodic condition is adopted at the two outlets of the simulated domain.

When solving the electrostatic field from the Laplace equation in equation (5), the zero charge condition (i.e., n·D=0) is adopted for the gaps between electrodes. In addition, the periodic condition that Vᵢₙ=Vₒᵤₜ is adopted at the outlets of the simulated domain.

TABLE 1
Material, interfacial, and geometric properties used for the simulation.

| Parameters | Quantity | Symbol | value | |
|---|---|---|---|---|
| Material | Density of oil | ρₒᵢₗ | 884 | kg m⁻³ |
| properties | Density of water | ρ_{water} | 999.62 | kg m⁻³ |
| | Viscosity of oil | μₒᵢₗ | 2 | cP |
| | Viscosity of water | μ_{water} | 1.0093 | cP |
| | Dielectric constant of oil | εₒᵢₗ | 2.2 | |
| | Dielectric constant of water | ε_{water} | 80 | |
| | Dielectric constant of | ε_{hyd} | 3 | |
| | hydrophobic dielectric layer | | | |
| Interfacial | Surface tension of oil and | γ_{ow} | 40 | mN m⁻¹ |
| properties | water | | | |

| | | |
|---|---|---|
| Contact angle of hydrophobic | θ_{hyd} | 160° |
| surface | | |

Here the finite element method (FEM) is utilized to solve all of the governing equations including the Cahn-Hilliard equation for detecting the dynamic moving interface between oil and water phase, the Laplace equation for calculating the electric field distribution, and the Navier-Stokes equation for solving the velocity field distribution.

The hydrophobic dielectric used in the simulation consists of a stack of 1.5 μm dielectric layer and 0.2 μm hydrophobic layer with the permittivity 3∈₀ and 2∈₀, respectively. Here, a dielectric oil film thickness of 4.7 μm with 3∈₀ is adopted. In addition, the contact angle of the grid is set to 90°, which ensures that the oil film is initially flat in the pixel in the absence of voltage. The term contact angle used in this paragraph refers to the contact angle of the hydrophilic grid in an electrowetting display pixel, and is not the same as an electrowetting contact angle above discussed regarding earlier examples. The hydrophilic grid is a solid surface, but it does not have an electrode which can provide an electric field. In the experiments, and as predicted by theory, the dominant dewetting wavelength for the oil film will exhibit a dependence of the abruptly applied voltage (increased voltage magnitude, shorter dominant dewetting wavelength, increased number of smaller volume oil droplets). As shown in FIG. 8, the number of oil droplets versus applied voltage for various pixel sizes (l) is plotted vs. increasing voltage. The droplet counts plotted in FIG. 8 increase linearly with increasing voltage. The inset photographs are the model results showing the periodically dewetted oil droplets subjected to 80 V in the pixel sizes l=150, 300, and 600 μm.

FIG. 8 depicts the plot of the number of oil droplets versus applied voltage for various pixel sizes (l) with the oil thickness dₒᵢₗ=4.7 μm. The symbols represent the simulation results, and the solid lines denote the theoretically predicted result.

In an another example, the insulating fluid 21 may be a gas, such as nitrogen or argon or other suitable gas. In this case, the conducting fluid 19 should remain wetted on the top substrate, or any adjacent layers that cover the top substrate 11. The surface tension of the conducting fluid would then be used to sustain a stable meniscus geometry whether static or propagating. In such an approach, it would be desirable that the hydrophobic dielectric be hydrophobic or even superhydrophobic, to help retain a gas layer throughout the device. Such an alternate approach could benefit from higher refractive power and/or faster switching speeds. The same principles as taught for use of an insulating liquid apply to use of a gas as well. Since for the insulating fluid the use of gas or liquid can be reasonably equivalent, the term fluid may also include a gas since a gas can flow with fluid like properties as well.

In an another example, the optical property imparted by the interface between the insulating and conducting fluids may also be optical reflection. For example, the conducting fluid could be a liquid metal such as GaInSn alloy which has a reflective surface. As a further example, reflective Janus particles or small reflective micro materials can be dispersed at the interface between the conducting and insulating fluids. Example techniques could be similar to those taught by Hou, Smith, and Heikenfeld in APPLIED PHYSICS LETTERS 90, 251114, 2007. Such technology could be useful for reflective steering of lighting. Such technology could also be useful for creating reflective displays which direct light toward the users eyes as needed, for example by steering by reflection the ambient light to the users eyes to create a bright pixel, or steering it away from the users eyes to create a dark pixel. A particular advantage of such a display devices is that in such a reflective mode such a device would provide adaptive optical gain of the reflection, and could appear even brighter than reflection from paper, for example.

The description above references a controller or voltage source that also measures capacitance at one or more electrodes. The term capacitance can include any measure of voltage, charge, current, dynamic response of a meniscus to voltage such as change in capacitance, or any other measure which one or more electrodes can utilize to sensor or predict the local geometry or thickness of the insulating fluid.

Applications of the electrofluidic technologies were illustrated primarily for optical applications, but one skilled in the art of microfluidic would recognize numerous other non-optical applications, such as using propagating or static waves for transport of particles or fluids, for applications such as lab-on-chip technologies.

The Summary and Abstract sections may set forth one or more but not all examples and thus are not intended to limit the scope of the present disclosure or the appended claims in any way.

Examples have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of specific examples will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptation and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described examples, but should be defined only in accordance with the following claims and their equivalents.

What is claimed is:

1. An apparatus, comprising:
a first substrate;
a second substrate spaced from the first substrate to form a volume between the first and second substrates;
first and second fluids, immiscible with respect to each other, in the volume between the first and second substrates,
the first fluid being insulating and nearest to the first substrate, and the second fluid being conductive and nearest to the second substrate;
electrodes formed adjacent to the first substrate and adjacent to the first fluid, at locations distributed across the surface of the first substrate;
each respective one of the electrodes being configured to generate an electric field in the vicinity of the respective electrode extending through the first fluid, in response to a respective voltage applied to the respective electrode; and
a controller coupled to control respective voltages applied to the electrodes to generate a complex waveform geometry at an interface between the first and second fluids.

2. The apparatus of claim 1, wherein the controller is further configured to control respective voltages applied to the electrodes so as to generate the waveform geometry without need for a contact angle change for the second fluid on an adjacent solid surface.

3. The apparatus of claim 1, further including a coating over surfaces of the electrodes, and in-between (a) the first fluid and (b) the surfaces of the electrodes and the surface of the first substrate.

4. The apparatus of claim 3, wherein the coating is a dielectric and/or is hydrophobic.

5. The apparatus of claim 1, wherein the controller is further configured to take a measure of electrical capacitance between one of the electrodes and the second fluid.

6. The apparatus of claim 5, wherein the controller is further configured to:
determine when the measured capacitance level is at an upper threshold for a period of time; and
decrease the voltage level applied to the one electrode when the capacitance level is at the upper threshold indicating that the thickness level of the first fluid has reached a minimum.

7. The apparatus of claim 6, wherein the decrease in the voltage level when the capacitance level is at the upper threshold increases the thickness level of the first fluid to prevent complete dewetting by the second fluid.

8. The apparatus of claim 6, wherein the controller is further configured to:
measure the capacitance level at the one electrode to determine when the capacitance level is at a lower threshold for the period of time; and
increase the voltage level applied to the one electrode when the capacitance level is at the lower threshold indicating that the thickness level of the second fluid has reached a maximum,
wherein the increase in the voltage level when the capacitance level is at the lower threshold decreases the thickness level of the first fluid.

9. The apparatus of claim 1, wherein the first fluid is always between the second fluid and at least one of the electrodes carried by the first substrate.

10. The apparatus of claim 1, wherein the complex waveform geometry is static and comprises a non-symmetrical and/or non-spherical geometry.

11. The apparatus of claim 1, wherein the complex waveform geometry comprises a propagating wave.

12. The apparatus of claim 1 wherein the first fluid and the second fluid are different in refractive index.

13. The apparatus of claim 4, wherein the controller is further configured to control respective voltages applied to the electrodes to at least substantially prevent dewetting of the dielectric and/or hydrophobic coating by the first fluid and/or wetting of the dielectric and/or hydrophobic coating by the second fluid.

14. The apparatus of claim 13, wherein the controller is further configured to control respective voltages applied to the electrodes to dynamically modulate thickness of the first fluid in an incomplete dewetting state relative to the dielectric and/or hydrophobic coating.

15. The apparatus of claim 1, wherein the controller is further configured to provide a sequence of voltages to a plurality of electrodes to enable a propagating waveform.

16. The apparatus of claim 15, wherein the controller further prevents the complete dewetting of a surface of the first substrate or a surface carried by the first substrate by the second fluid.

17. The apparatus of claim 15, wherein the controller is further configured to:
adjust the voltage level of each electrode from a maximum voltage level to a minimum voltage level after the waveform generated by each respective electrode reaches each succeeding electrode; and
adjust the voltage level of each electrode from the minimum voltage level to the maximum voltage level when the waveform generated by each respective preceding electrode reaches each succeeding electrode,
wherein the adjustment of the voltage level of each electrode between the maximum voltage level and the minimum voltage level generates the propagating waveform while preventing the complete dewetting of a surface of the first substrate or a surface carried by the first substrate by the second fluid.

18. The apparatus of claim 1, wherein the controller is further configured to adjust each voltage level of each electrode to generate a Fourier series approximation of a waveform that is imparted on the first fluid.

19. The apparatus of claim 18, wherein the controller is further configured to adjust a thickness level of the first fluid at each electrode based on the Fourier series approximation of the waveform that is imparted on the first fluid.

20. The apparatus of claim 1, wherein the apparatus is configured as at least one tunable optical element selected from the group consisting of: a lens, a prism, an array of lenses, an array of prisms, a diffraction grating, an optical phased array or a Fresnel lens.

21. The apparatus of claim 1, wherein the apparatus is configured as two or more optical elements that impart different optical effects.

22. The apparatus of claim 1, wherein the apparatus is configured to transport at least one fluid.

23. The apparatus of claim 1, wherein the apparatus is configured as a tunable optically reflective element.

24. The apparatus of claim 23, further comprising nano or micro-particles suspended between the first and second fluids to provide reflectivity at the interface, to configure the apparatus as the tunable optically reflective element.

25. An apparatus, comprising:
a substrate;
first and second fluids, immiscible with respect to each other,
the first fluid being insulating and located between the substrate and the second fluid;
a first electrode formed adjacent to the substrate and adjacent to the first fluid;
the first electrode being configured to generate an electric field in the vicinity of the first electrode extending through the first fluid, in response to a voltage applied to the first electrode;
a second electrode in contact with one of the fluids; and
a controller coupled to the electrodes configured to measure capacitance between the first and second electrodes as an indication of thickness of the first fluid in vicinity of the first electrode and to control the voltage applied to the first electrode in response to the sensed capacitance.

26. The apparatus of claim 25, wherein the controller is further configured to control the voltage applied to the first electrode to at least substantially prevent dewetting of a surface of the substrate or a surface carried by the substrate by the first fluid and/or wetting by the second fluid in the vicinity of the first electrode in response to the sensed capacitance.

27. An apparatus, comprising:
a substrate;
first and second fluids, immiscible with respect to each other,
the first fluid being insulating and located between the substrate and the second fluid;
electrodes formed on or in a surface of the substrate adjacent to the first fluid, at locations distributed across the surface of the substrate;
each respective one of the electrodes being configured to generate an electric field in the vicinity of the respective electrode extending through the first fluid, in response to a respective voltage applied to the respective electrode; and
a controller coupled to vary respective voltages applied to the electrodes to generate a propagating wave at an interface between the first and second fluids.

28. The apparatus of claim 27, wherein the controller is further configured to control respective voltages applied to the electrodes to at least substantially prevent dewetting of a surface of the substrate or a surface carried by the substrate by the first fluid and/or wetting of the dielectric by the second fluid.

29. The apparatus of claim 28, wherein the controller is further configured to control respective voltages applied to the electrodes to dynamically modulate thickness of the first fluid in an incomplete dewetting state relative to a surface of the substrate or a surface carried by the substrate.
